(19) United States
(12) Patent Application Publication
(10) Pub. No.: US 2024/0349807 A1
(43) Pub. Date: Oct. 24, 2024

(54) Heating Element for a Consumable Article, and Associated Consumable Kit, Vaping Set and Method for Producing an Aerosol

(71) Applicant: JT International S.A., Geneva (CH)

(72) Inventors: Stephane Hedarchet, Geneva (CH); Jaakko McEvoy, Vienna (AT)

(73) Assignee: JT International S.A., Geneva (CH)

(21) Appl. No.: 18/685,446

(22) PCT Filed: Sep. 1, 2022
(86) PCT No.: PCT/EP2022/074292

§ 371 Date: Feb. 21, 2024

(30) Foreign Application Priority Data
Sep. 3, 2021 (EP) 21194908.6
Dec. 23, 2021 (EP) 21217495.7

(51) Int. Cl. A24F 40/465; A24D 1/20; A24F 40/20; A24F 40/46; H05B 3/22; H05B 6/10

(52) U.S. Cl. CPC A24F 40/465; A24D 1/20; A24F 40/20; A24F 40/46; H05B 3/22; H05B 6/108

(57) ABSTRACT

A heating element for a consumable article, the consumable article including a storage portion storing a vaporizable material, includes an element body configured to be engaged in an engaged position at least partially around the storage portion of the consumable article and the element body is configured to be removably received at least partially in an energy supplying cavity of an external energy supplied device.

The element body includes a heat absorbing/releasing material able to:
absorb heat during a pre-heating phase carried out when the element body is received with this consumable article in the energy supplying cavity; and
while the element body is in the engaged position with the consumable article, release the absorbed heat to during a vaping phase.

### FIELD OF THE INVENTION

The present invention concerns a heating element for a consumable article, as for example a tobacco article, presenting a reduced risk for the consumer's health in comparison with conventional tobacco articles, as for example conventional cigarettes.

The present invention also concerns a consumable article, a consumable kit, a vaping set and a method for producing an aerosol associated to such a heating element.

### BACKGROUND OF THE INVENTION

The popularity and use of reduced-risk or modified-risk devices (also known as vaporisers or aerosol generating devices) has grown rapidly in recent years as an alternative to the use of traditional tobacco products. Various devices and systems are available that heat or warm aerosol generating substances to generate an aerosol for inhalation by a user.

Aerosol generating consumable articles with a carbon-base heating source of substantially the same size as conventional cigarettes have been proposed. The source of carbon is lit as a cigarette and heats the vaporizable substrate positioned adjacent to it. These consumable articles had the advantage to be as small as conventional cigarettes and to be easy to handle when vaping. However, burning solid fragments or parts (e.g. charcoal) had a tendency to dissociate from the rest of the consumable thereby creating burning risks for the consumer. Therefore, these consumable articles did not reach so far significant commercial success.

One more recent type of commonly available reduced-risk or modified-risk device is the heated substrate aerosol generating device, or so-called heat-not-burn device (or HNB device). Devices of this type generate an aerosol or vapour by heating an aerosol generating substrate to a temperature typically in the range 150° C. to 350° C. Heating the aerosol generating substrate to a temperature within this range, without burning or combusting the aerosol generating substrate, generates a vapour which typically cools and condenses to form an aerosol for inhalation by a user of the device.

Some devices of this type can operate with consumable articles, having for example an elongated shape which can resemble the external shape of a conventional cigarette. Such consumable articles may comprise a substrate part and a mouthpiece part. The substrate part contains generally an aerosol generating substrate and is designed to be received inside the device to be heated by a heating system. The mouthpiece part can protrude from the device and is designed to cooperate with the user's lips and/or mouth. However, for some users, this type of devices differs from the conventional cigarette experience in that a device is handled while vaping and the device cannot be manipulated in the same way as a conventional cigarette.

Other devices can have an elongated shape which is closer to the shape of a conventional cigarette. However, due to the embedded technology (e.g., battery, heater, printed circuit board) necessary for heating the substrate and properly controlling vaporization for several successive puffs, these devices remain largely bigger than a conventional cigarette and therefore provide a different user experience compared to the conventional cigarette. Therefore, in view of the need for constantly handling these devices by the consumer during vaping, the consumer experience conferred by these devices to habitual smokers is different from the one of conventional cigarettes.

### SUMMARY OF THE INVENTION

One of the aims of the invention is to provide a heating element for a consumable article to ensure a reduced-risk tobacco consumption while providing a handling experience similar to the one of a conventional cigarette.

For this purpose, the invention relates to a heating element for a consumable article, the consumable article comprising a storage portion storing a vaporizable material, the heating element comprising an element body configured to be engaged in an engaged position at least partially around the storage portion of the consumable article and the element body being configured to be removably received at least partially in an energy supplying cavity of an external energy supplied device;
the element body comprising a heat absorbing/releasing material able to:
absorb heat during a pre-heating phase carried out when the element body is engaged with the consumable article and received in the engaged position with this consumable article in the energy supplying cavity of the external energy supplied device;
while the element body is in the engaged position with the consumable article, release the absorbed heat to the storage portion to the vaporizable material during a vaping phase carried out upon a triggering event.

According to these features, the heating element engaged with the consumable article is able to confer a user experience closer to the one of a conventional cigarette. Particularly, the consumable article used with the heating element according to the invention may be sized and/or shaped similarly to a conventional cigarette and the user can experience the ease of handling the consumable article with the heating element in a way similar to a conventional cigarette while reducing harmful risks on his/her health in comparison with the conventional cigarettes.

The heating element according to the invention can be used in a simple way. During the pre-heating phase, the element body is engaged with the consumable article and both are received in the energy supplying cavity so as the heat absorbing/releasing material of the element body can absorb heat generated directly or indirectly by the external energy supplied device. During the vaping phase, the element body with the engaged consumable article are removed from the energy supplying cavity and thus, can be handled by the user as a conventional cigarette. During this vaping phase, the heat absorbed by the heat absorbing/releasing material is released to the storage portion and the vaporizable material can thus be heated enough and for a sufficient time, without being burnt, to generate aerosol. Aerosol is preferably generated for at least a minimal number of successive puffs (e.g. 10 or 11 puffs) or at least for a minimal amount of time (e.g. 180 or 300 seconds) to provide a full vaping session. As for the heat absorbing/releasing material, any type of thermal energy storage (TES) materials can be used. In a particular embodiment, the heat absorbing/releasing material comprises phase change material or ceramic. Heat absorbing/releasing can be carried out by thermal phenomena or thermochemical phenomena. In this last case, chemical reactions may occur at least during one of the pre-heating and vaping phases.

The heating element according to the invention is thus removable.

As used herein, the term “vaporizable material” or “aerosol-forming precursor” or “aerosol material” may refer to one or more of a: liquid; solid; gel; mousse; foam or other substances. The vaporizable material may be heated to form an aerosol as defined below. The vaporizable material may comprise one or more of: nicotine; caffeine or other active components. The active component may be carried by a carrier, which may be a liquid. The carrier may comprise an aerosol former such as polyols. In some embodiments, the aerosol former comprises one or more of polyhydric alcohols, such as propylene glycol, 1,3-butanediol and glycerin, ester of polyhydric alcohols, such as glycerol mono-, di- or triacetate; and/or aliphatic esters of mono-, di- or poly-carboxylic acids, triethyl citrate (TEC), or triacetin. A preferred carrier may be propylene glycol and/or glycerin. The carrier is vaporized upon heating, generally at a temperature of about 350° C. or lower. A flavoring may also be present. The flavoring refers to substances which may be sued to create a desired taste or aroma. They may include naturally occurring flavor materials, botanicals, extracts of botanicals, synthetically obtained flavoring substances, or combinations thereof. The flavoring may include, e.g. Ethylvanillin (vanilla), menthol, berry, Isoamyl acetate (banana oil), eugenol, cooling agent (e.g., eucalyptol, WS-5 or WS-3) or similar. A solid aerosol forming substance may be in the form of a rod, which contains processed tobacco material, a crimped sheet or oriented strips or shreds of reconstituted tobacco (RTB).

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the vaporizable material.

As used herein, the term “pre-heating phase” may refer to a phase used to heat the heat absorbing/releasing material. In other words, during the pre-heating phase, heat is absorbed by the heat absorbing/releasing material. Advantageously, the pre-heating phase is carried out until the heat absorbing/releasing material absorbs heat according to its maximal capacity. In some embodiments, the pre-heating phase may also be carried out to pre-heat the vaporizable material to be able to generate aerosol. Advantageously, during the pre-heating phase, the heating element is engaged with the consumable article and both are received in the energy supplying cavity of the external energy supplied device. In some embodiments, during the pre-heating phase, only the consumable article is received in the energy supplying cavity. The pre-heating phase can be carried out until a triggering event. The triggering event may comprise at least one of: the achievement of a predetermined temperature of the vaporizable material in the storage portion or the expiry of a predetermined time delay or the achievement of a predetermined pressure in a neighbourhood of the consumable article or the consumption of a predetermined amount of energy from a power source.

As used herein, the term “vaping phase” may refer to a phase which is carried out after at least one pre-heating phase wherein the vaporizable material is able to generate aerosol. Particularly, the vaping phase can be carried out according to at least two operation modes. In an out-of-device mode, the heating element is engaged with the consumable article and both are extracted from the energy supplying cavity. For example, the heating element together with the consumable article can be handled by the user, for example like a traditional cigarette. In this operation mode, the heat absorbed by the heat-absorbing material is released to the storage portion to heat the vaporizable material. In an in-device mode, the consumable article with or without the heating element is (are) received in the energy supplying cavity. In this mode, the vaporizable material is heated by the heat absorbing/releasing material and/or by a heater to generate aerosol. According to both modes, during the vaping phase, the user may exert puffs to generate an airflow inside the consumable article or the consumable article may be kept without exerting puffs. This last case may correspond to pauses between puffs exerted by the user as during smoking a conventional cigarette.

The external energy supplied device can be portable and can be carried together with the consumable article by the user, when the consumable article is not used to generate vapor. The external energy supplied device can be formed by a device similar to an aerosol generating device, such as an HNB device, known in the art. Particularly, similarly to such an aerosol generating device, it can comprise a battery and a heater or any other heat inducing element, called hereinafter heat generator. Such a heat generator can be adapted to heat the heating element or to cause its heating during the pre-heating phase. In some embodiments, the external energy supplied device can form itself an aerosol generating device, as an HNB device, which can be used directly with the consumable article, without the heating element.

The element body of the heating element in the engaged position with the consumable article may be adapted to be received in the energy supplying cavity according to at least 50% of the its total volume, advantageously according to at least 75% and preferably according to at least 90% of its total volume. In the preferred embodiment of the invention, the element body is adapted to be received entirely inside the energy supplying cavity.

The consumable article can be designed for a single use or multiple uses. In the first case, it can be discarded or recycled after the use. In the second case, it is possible to make it last through several vaping sessions. The consumable article may be formed by a cigarette known in the art for example for using with HNB devices.

The heating element may be reusable, notably with different consumable articles. For example, when aerosol generating capacity of a consumable article is exhausted, the heating element can be disengaged from the consumable article and reused with another consumable article. In this case, a new pre-heating phase may be necessary before vaping.

According to some embodiments, said heat absorbing/releasing material is a phase change material (PCM) able to absorb/release heat during its phase changing.

Using a phase change material (PCM) can present a particular advantage of the invention since this type of material has high heat storage capacities. These storage capacities can thus be used to store a greater amount of heat during the pre-heating phase and release this amount of heat during the whole duration of the vaping session. Thus, the vaporizable material can be heated homogeneously during the whole vaping session. Additionally, the phase change materials are latent heat storage materials that means that the different phase transitions (solid-liquid or liquid-gas) of these materials occur isothermally. In other words, during the phase transitions, heat can be absorbed or released for longer time periods, without changing the material's temperature. These time periods can be used to carry out the pre-heating phase for absorbing heat and the vaping phase for releasing heat to evaporate the vaporizable material with a constant temperature. Moreover, by choosing the phase change material in an appropriate manner, it is possible to adjust the duration of each of the pre-heating and vaping phases. Particularly, the phase change material can be chosen according to the duration of its phase transitions.

According to some embodiments, said phase change material (PCM) is chosen to melt during the pre-heating phase and solidify during the vaping phase.

Thanks to these features, the particular solid-liquid phase transition of the phase change material is used. In comparison with the liquid-gas phase transition, the solid-liquid phase transition can be more easily carried out while operating the heating element with the engaged consumable article in normal conditions (normal atmospheric pressure, ambient temperature, etc.)

According to some embodiments, said phase change material (PCM) comprises an inorganic PCM, such as a salt, a eutectic mixture of salts or salt hydrates.

This type of phase change material is particularly useful in the context of the invention since their phase transition temperature (as for example the melting temperature) is comprised between 150° C. and 450° C., advantageously between 200° C. and 400° C. This temperature range is particularly suitable for evaporating the vaporizable material without burning it. Additionally, this type of phase change material has greater heat storage capacities in comparison with other phase change materials. Additionally, this type of phase change material is cheap, abundant and non-flammable.

According to some embodiments, the phase change material (PCM) comprises a solid-to-solid PCM. For example, such a material can change from a crystalline, semi-crystalline, or amorphous structure to another solid structure, and have lower latent heats available.

According to some embodiments, the phase change material (PCM) is an organic PCM such as paraffin wax.

According to some embodiments, the phase change material (PCM) is an organic PCM mixed with another PCM (for example inorganic) or a metal. For example, in case of a paraffin wax which has a relatively low operating temperature, other materials such as salts or metals can mixed with (such as Mg—Zn).

According to some embodiments, the heating absorbing/releasing material further comprises an additive able to interact with the phase change material (PCM) in liquid form to change its solidification temperature during the vaping phase, in comparison with its melting temperature.

Using these features, the additive can ensure that the melting temperature of the phase change material is different from its solidification temperature. The melting temperature can for example be less, at least slightly, than the solidification temperature. Thus, the phase change material can release latent heat at a temperature greater than the temperature of its absorption. The solidification temperature can be adapted to evaporate the vaporizable material whereas the melting temperature only to pre-heat the vaporizable material. Thus, it is possible to avoid undesirable evaporation of the vaporizable material during the pre-heating phase. The additive can be a chemical component adapted to carry out a chemical reaction modifying at least some properties of the phase change material during the vaping phase. In case where the phase change material (PCM) comprises a salt or a eutectic mixture of salts, such a chemical reaction can for example modify the concentration of these salts or their nature or the mixture composition.

According to some embodiments, the element body further comprises a heater able to:
during the pre-heating phase, generate heat and transfer this heat to the heat absorbing/releasing material; and/or
during the vaping phase, transfer heat from the heat absorbing/releasing material to the vaporizable material;
preferably, the heater comprising at least one susceptor able to generate heat upon inductive interaction with the external energy supplied device.

In a possible mode, the heater comprising at least one susceptor able to generate heat upon inductive interaction with the external energy supplied device.

Thanks to these features, heat can be generated by the susceptor(s) inside the heating element upon inductive interaction with the external energy supplied device comprising for example a magnetic coil. Thus, no heat transfer from the external energy supplied device to the heating element is necessary. The susceptor(s) can be made from any suitable material generating eddy currents when it is placed within a magnetic field.

According to some embodiments, the heater is designed to be arranged at least partially around the storage portion of the consumable article and/or penetrate the storage portion of the consumable article, when the element body is in the engaged position with the consumable article.

For example, the susceptor can be designed to be arranged fully around the storage portion. According to other examples, it is arranged only partially around the storage portion. Additionally, according to some examples, the susceptor is designed only to penetrate the storage portion. In this case, it can for example comprise a blade. In some other examples, the susceptor comprises at least two parts: one part is adapted to penetrate the storage portion and another part is designed to be arranged at least partially around the storage portion.

Thanks to these features, the heat generated by the susceptor can be efficiently transferred to the storage portion during the pre-heating phase. During the vaping phase, the heat stored by the heat absorbing/releasing material can be efficiently transmitted to the storage portion to evaporate the vaporizable material.

According to some embodiments, the heater is designed to be interposed between the storage portion of the consumable article and the heat absorbing/releasing material, when the element body is in the engaged position with the consumable article.

Thanks to these features, an optimal position of the susceptor inside the heating element can be achieved. This position allows heat transferring from the susceptor simultaneously to the storage portion and the heat absorbing/releasing material during the pre-heating phase. Additionally, during the vaping phase, the heat can be efficiently transferred from the heat absorbing/releasing material to the storage portion. Thus, heat loss can be minimized.

According to some embodiments, the heater comprises a plurality of susceptors mixed with or embedded within the heat absorbing/releasing material. The susceptors may take various forms such as: particles, granules, beads, sheets, strips, wires, rings and combinations thereof.

Thanks to these features, heat can be homogenously transferred to the heat absorbing/releasing material.

According to some embodiments, the element body further comprises a protruding member designed to penetrate the storage portion of the consumable article, when the element body is in the engaged position with the consumable article;
the protruding member comprises a heater and/or at least a part of said heat absorbing/releasing material;
preferably, the heater comprising a susceptor.

Thanks to these features, the storage portion can be heated internally during the vaping phase. This ensures a better heat transfer to the vaporizable material from the heat absorbing/releasing material. The protruding member can be formed by a blade which penetrates the storage portion upon engaging the heating element with the consumable article. According to an advantageous embodiment of the invention, the protruding member comprises both heater and heat absorbing/releasing material. According to this last embodiment, both heater and heat absorbing/releasing material are received inside the storage portion of the consumable article which minimizes thermal losses.

According to some embodiments, the element body further comprises an insulator arranged at least partially around the heat absorbing/releasing material and/or configured to be arranged at least partially around the storage portion.

Thanks to these features, the insulator allows reducing heat loss to the exterior of the consumable article during the vaping phase. Additionally, the insulator makes it possible for the user to handle the consumable article engaged with the heating element during the vaping phase without being burnt.

For example, the insulator can form an external surface of the element body so as to isolate the heat absorbing/releasing material from the exterior. Thus, the heat can be transferred to the storage portion to heat the vaporizable material without being lost. In some embodiments, the insulator can be arranged in contact with the heat/absorbing releasing material and/or in contact with storage portion.

The insulator can be made from any appropriate material as for example paper, foam or honeycomb.

According to some other embodiments, the insulator can be formed by an aerogel insulation layer. This layer can be formed by spraying or coating the aerogel on a support layer arranged at least partially around the heat absorbing/releasing material. The support layer can be formed by a wall or by a wrapper delimiting the heat releasing/absorbing material. The aerogel presents a porous structure containing mainly air (with concentration which can achieve 97% of the total volume of the aerogel). The aerogel insulation layer has a particular advantage to ensure an efficient thermal insulation while being very thin, light and near invisible to the user. According to other embodiments, the insulator can be formed by any other heat resistant porous structure adapted to trap air for example honeycomb or crepe paper, or ceramic paper such as Superwool paper.

According to still other embodiments, the insulator can be formed from a phase change material (PCM) as defined above. This embodiment is particularly advantageous when the insulator is designed to cover at least partially the heat absorbing/releasing material. The PCM insulator can thus form an external layer of the heating element, like a shield. The PCM insulator can be adapted to have a temperature below for example 60° C. to be safe for the user while using the article with the engaged heating element during the vaping session. According to still other embodiments, the insulator can comprise a mixture of an aerogel as defined above and a PCM material.

According to some embodiments, the element body forms a ring or a cup able to be engaged with the consumable article by sliding along an article axis.

Thanks to these features, the heating element can be simply engaged with the consumable article while being in a tight contact with the storage portion. For example, the heating element can be slid along the consumable article. When the heating element is formed by a ring, the ring position in respect with the storage portion can be adjusted by the user. For example, when the user wishes to decrease the quantity of the aerosol generated during the vaping phase, he/she can simply slide the ring toward the filter portion of the consumable article. Additionally, during the vaping phase the position of the ring in respect with the storage portion can for example be continuously adjusted in order to heat different parts of the storage portion. When the heating element is formed by a cup, the corresponding end of the consumable article can abut against a bottom wall of the cup. Thus, the cup can be positioned accurately in respect with the storage portion of the consumable article. Additionally, in this case, the contact surface of the cup with the storage portion being increased, a more homogenous heating of the storage portion can be achieved.

According to some embodiments, the heating element further comprises anchoring means designed to fix the element body on the consumable article, when the element body is engaged with the consumable article.

Using the anchoring means, it is possible to fix the heating element in respect with the storage portion in a desired position. According to one example, this position is chosen by the user. Thus, the user can move the anchoring means (for example by sliding along the consumable article) to achieve this position. According to another example, the position is predetermined for example to ensure better heat transfer to the storage portion. In this case, this position can for example be marked on the consumable article and the user places or actuates the anchoring means in this position.

The anchoring means can for example be designed to extend around the consumable article and slightly compress it while actuating. Thus, the heating element can be retained in the desired positon. According to another embodiment, the anchoring means protrudes from the heating element and forms for example a needle or a blade configured to penetrate the consumable article to be fixed to it.

In an alternative embodiment, no anchoring means are provided. In this case, the heating element can for example be retained in the engaged position with the consumable article by friction. For this purpose, the heating element may for example slightly compress the consumable article.

According to some embodiments, the heating element further comprises an indicator able to indicate the capacity of the heat absorbing/releasing material to generate aerosol. Such an indicator may be sensitive to the temperature of the heat absorbing/releasing material or at least of its neighboring zones. It can for example comprise a heat-sensitive material like wax which changes its properties with temperature, like the volume or color. The indicator can indicate at least two states: one suitable for aerosol generation and one non-suitable for aerosol generation. According to other embodiments, one or several intermediate states are also possible.

The invention also relates to a consumable kit comprising:
one or several consumable articles;
a heating element as defined above, designed to be engaged with the or each consumable article.

Alternatively, the invention also relates to a consumable kit comprising:
a consumable article comprising a storage portion storing a vaporizable material; and
a heating element comprising a heat absorbing/releasing material able to:
   absorb heat during a pre-heating phase carried out when the consumable kit is received in an energy supplying cavity of an external energy supplied device;
   release the absorbed heat to the storage portion to the vaporizable material during a vaping phase carried out upon a triggering event.

The invention also relates to a vaping set, comprising:
an external energy supplied device comprising an energy supplying cavity;
a consumable article;
a heating element as defined above, designed to be in an engaged position with the consumable article and received in the engaged position with this consumable article in the an energy supplying cavity of the external energy supplied device to carry out a pre-heating phase.

Alternatively, the invention concerns a vaping set, comprising:
an external energy supplied device comprising an energy supplying cavity;
a consumable kit as defined above.

According to some embodiments, the external energy supplied device comprises at least one heat generator configured to heat the consumable article when it is received in the energy supplying cavity with or without the heating element to generate aerosol.

The invention also concerns a method for producing an aerosol from a consumable kit comprising a vaporizable material, the method comprising the following steps:
upon engagement of the consumable kit with an external energy supplied device, carrying out a pre-heating phase by heating a heating element of the consumable kit;
upon a triggering event, carrying out a vaping phase by heating the vaporizable material by the heating element.

According to some embodiments, the method comprises the following step:
upon engagement of the consumable kit with the external energy supplied device after the vaping phase, carrying out a recharging phase to re-heat the heating element.

According to some embodiments, the duration of each of the vaping phase and the recharging phase is adapted to habits of conventional cigarette smokers.

The invention also relates to a consumable article comprising:
a storage portion storing a vaporizable material;
a heating portion comprising a heat absorbing/releasing material able to absorb heat during a pre-heating phase carried out when the consumable article is engaged with an external energy supplied device, and release the absorbed heat to the storage portion to the vaporizable material during a vaping phase carried out when the consumable article is disengaged from the external energy supplied device.

According to some embodiments, the heating portion is configured to be received in an energy supplying cavity formed by the external energy supplied device when the consumable article is engaged with this external energy supplied device.

According to some embodiments, said heat absorbing/releasing material is a phase change material (PCM) able to absorb and release heat during its phase changing.

According to some embodiments, said phase change material (PCM) comprises an inorganic PCM, such as a salt, a eutectic mixture of salts or salt hydrates.

According to some embodiments, the phase change material (PCM) comprises a solid-to-solid PCM. For example, such a material can change from a crystalline, semi-crystalline, or amorphous structure to another solid structure, and have lower latent heats available.

According to some embodiments, the phase change material (PCM) is an organic PCM such as paraffin wax.

According to some embodiments, the phase change material (PCM) is an organic PCM mixed with another PCM (for example inorganic) or a metal. For example, in case of a paraffin wax which has a relatively low operating temperature, other materials such as salts or metals can mixed with (such as Mg—Zn).

According to some embodiments, the heating portion further comprises an additive able to interact with the phase change material (PCM) in liquid form to change its solidification temperature during the vaping phase, in comparison with its melting temperature.

According to some embodiments, the heating portion further comprises at least one heat transfer element configured to transfer heat generated by the external energy supplied device to the heat absorbing/releasing material during the pre-heating phase and/or be configured to transfer heat from the heat absorbing/releasing material to the aerosol vaporizable material during the vaping phase.

As a result, heat can be more easily transferred from the external energy supplied device to the heat absorbing/releasing material for example by an appropriate heater and/or from the heat absorbing/releasing material to the vaporizable material. The heat transfer element can for example be integrated in the heat absorbing/releasing material to facilitate heat transfer. It can be made of metal forming for example a foil, grid, mesh or particles within the heat absorbing/releasing material. Additionally, the heat transfer element can facilitate heat transfer from the heat absorbing/releasing material to the vaporizable material during the vaping phase.

According to some embodiments, the heating portion are formed by a plurality of heating elements, each heating element comprises or forms a susceptor able to generate heat upon magnetic interaction with the external energy supplied device and transfer this heat to the heat absorbing/releasing material. The susceptor may be arranged in contact with the heat absorbing/releasing material.

Thanks to these features, heat can be generated by the susceptor(s) upon magnetic interaction with the external energy supplied device comprising for example a magnetic coil. Thus, no heat transfer from the external energy supplied device to the consumable article is necessary. The susceptor(s) can be made from any suitable material generating eddy currents when it is placed within a magnetic field.

According to some embodiments, the susceptors are coated by a coating layer formed from the heat absorbing/releasing material.

Thanks to these features, it is possible to ensure an efficient heat transfer between the susceptors and the heat absorbing/releasing material.

According to some embodiments, the heating portion is integrated into the storage portion so as the susceptors are mixed with the vaporizable material.

Thanks to these features, it is possible to ensure an efficient heat transfer from the heat absorbing/releasing material to the vaporizable material.

According to some embodiments, the consumable article further comprises an insulator arranged at least partially around the heating portion and/or the storage portion at least during the vaping phase, to reduce heat loss to the exterior of the consumable article while it is being used to generate aerosol. For example, the insulator can be arranged only around the part of the heating portion and/or storage portion facing the exterior of the consumable article. Thus, the heat can be transferred to the storage portion to heat the vaporizable material without being lost.

The insulator can be made from any appropriate material as for example paper or foam.

According to some other embodiments, the insulator can be formed by an aerogel insulation layer.

According to still other embodiments, the insulator can be formed from a phase change material (PCM) as defined above.

Additionally, at least in the embodiments where the heating portion is heated by direct heat transfer from the external energy supplied device during the pre-heating phase, the insulator can be at least partially removable to allow heat transfer to the heating portion. For example, the insulator can comprise an insulation sleeve or ring slidable along an article axis between a rest position in which it does not cover the heating portion and an insulating position in which it covers partially the heating portion. In the rest position, the insulator can for example be at least partially around of a filter/cooler portion of the article. During the pre-heating phase, the insulator is in the rest position and during the vaping phase, the insulator is in the insulating position.

In some embodiments, instead of sliding along the article axis, the insulator can have a half-cylindrical shape and can be mounted rotary in respect with the article axis. For example, when the heating portion has also a half-cylindrical shape, the heating portion can be uncovered in the rest position of the insulator (i.e. during the pre-heating phase) and covered in the insulating position of the insulator (i.e. during the vaping phase). Switching between the rest and insulating positions can be performed by rotating the insulator at 180°.

In some embodiments, the insulator can be configured to slide or rotate automatically from the rest position to the insulating position upon extraction of the consumable article from the external energy supplied device. For example, the insulator may be moved by a driving member of the device while the consumable is extracted from the device. In the embodiments where heat is generated inside the heating portion (e.g. by at least one susceptor further to its magnetic interaction with a coil), the consumable article can further comprise an insulator arranged at least a partially around the heating portion in a fixed manner. It can for example be formed by a wrapper.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of a consumable kit according to a first embodiment of the invention, the consumable kit comprising a consumable article and a heating element, the heating element being in a disengaged position;

FIG. 2 is a schematic view of the consumable kit of FIG. 1 where the heating element is in an engaged position;

FIG. 3 is a schematic view of different examples of the heating element of FIG. 1 when it forms a cup;

FIG. 4 is a schematic view of different examples of the heating element of FIG. 1 when it forms a ring;

FIG. 5 is a graphic showing a phase transition of a heat absorbing/releasing material used in the heating element of FIG. 1;

FIG. 6 is a schematic view of an example of a vaping set according to the invention, the vaping set comprising the consumable kit of FIG. 1 and an energy supplied device; and

FIG. 7 is a schematic view of another example of a vaping set according to the invention;

FIG. 8 is a schematic view of a consumable kit according to a second embodiment of the invention; and

FIG. 9 is a schematic view of a consumable kit according to a third embodiment of the invention.

### DETAILED DESCRIPTION

### First Embodiment of the Invention

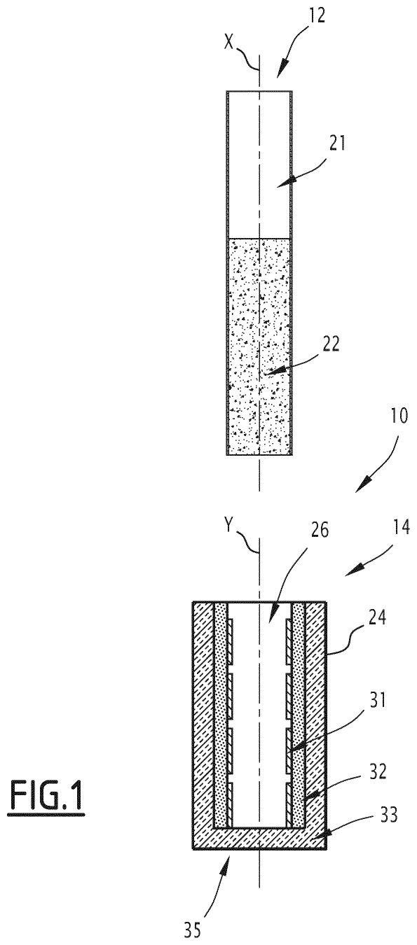

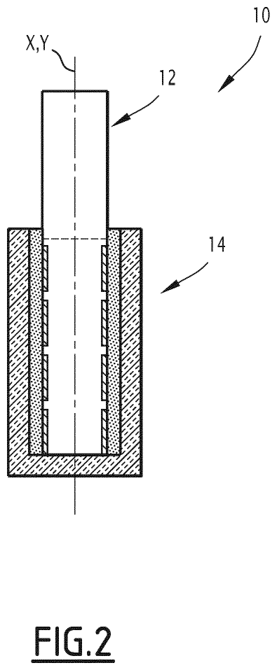

A consumable kit 10 according to the first embodiment of the invention is shown in FIG. 1. According to this Figure, the consumable kit 10 comprises a consumable article 12 and a heating element 14 which is separated from the consumable article 12 and which can be engaged with the consumable article 12 as it is shown in FIG. 2.

In the example of FIG. 1, the consumable article 12 is in its disengaged position with the heating element 14. The consumable article 12 extends according to an article axis X and has a generally cylindrical shape. This cylindrical shape is circular in cross-section along its length. Advantageously, according to the invention, the consumable article 12 has a shape and/or dimensions which are substantially equal to those of a conventional cigarette or an HNB article (heat-not-burn article). However, in some alternate embodiments, the consumable article may have other handy shapes than a conventional cigarette, such as parallelepipedal type, pebble type shape, etc. The consumable article 12 may also be of larger size (e.g. in longitudinal or circumferential direction) than a conventional cigarette without it being detrimental to the way it is handled and consumed by the user.

Advantageously, according to the invention, the consumable article 12 is a conventional cigarette or is a known HNB article.

In reference to FIG. 1, the consumable article 12 comprises a filter/cooler portion 21 and a storage portion 22. These portions can be assembled together by a common wrapper (not shown) comprising paper, aluminium foil or combinations thereof. In the example of FIG. 1, the filter/cooler portion 21 extends according to the article axis X and is adjacent to the storage portion 22. The storage portion 22 also extends along the article axis X and can for example be slightly longer than the filter/cooler portion 21. According to another example, the storage portion 22 has the same length as the filter/cooler portion 21 or is shorter than this filter/cooler portion 21.

The filter/cooler portion 21 forms a mouth end of the consumable article 12 designed to be in contact with the user's mouth/lips. This portion 21 contains filter and/or cooling segments designed to filter and/or cool the aerosol formed by the storage portion 22 further to its heating. For example, the filter/cooler portion 21 may comprise filter segment(s) at the mouth end of the article and a tubular element (e.g. paper tube) between the filter segment(s) and the storage portion 22. In some embodiments, no filter/cooler portion 21 is provided. In this case, for example the storage portion 22 can form the mouth end of the article 12. In this case, an exchangeable filter/cooler mouthpiece can be used which can be connected to the consumable article 12.

The storage portion 22 contains a vaporizable material as defined above.

The heating element 14 comprises an element body 24 extending along an element axis Y and forming a receiving cavity 26 adapted to receive at least partially the consumable article 12. The receiving cavity 26 extends for example according to the element axis Y.

Particularly, according to the example of FIGS. 1 and 2, the receiving cavity 26 is adapted to receive entirely the storage portion 22, as it is shown in FIG. 2. In the example of this FIG. 2, the heating element 14 is in an engaged position where the storage portion 22 is entirely received in the receiving cavity 26 so as the article axis X and the element axis Y coincide between them. Advantageously, the length of the storage portion 22 is substantially equal to the length of the receiving cavity 26.

The cross-sectional shape of the receiving cavity 26 corresponds for example to the cross-sectional shape of the consumable article 12. In this case, the heating element 14 may further comprise anchoring means (not shown) designed to fix the element body 24 in a desired position in respect for example with the storage portion 22 of the consumable article 12. According to one example, the anchoring means comprise protruding surfaces designed to protrude radially in the interior part of the receiving cavity 26 to fix the heating element 14 by friction. According to another example, the anchoring means comprise a needle or blade designed to protrude from the receiving cavity 26 and penetrate the consumable article 12 to fix it in the engaged position.

According to another example, no anchoring means are provided. In this case, the cross-section of the receiving cavity can be slightly smaller than the cross-section of the consumable article 12 so as to compress and fix it in the receiving cavity 26.

Referring again to FIG. 1, the element body 24 comprises a heater 31, a heat absorbing/releasing material 32 and an insulator 33. In some embodiments, the element body 24 can further comprise an indicator (not-shown) arranged for example on its surface and able to indicate the capacity of the heat absorbing/releasing material 32 to generate aerosol.

In the example of FIG. 1, the heater 31 forms at least partially an internal wall of the receiving cavity 26 and is designed to be in contact with the storage portion 22 of the consumable article 22. The heater 31 is designed to heat simultaneously the heat absorbing/releasing material 32 and the storage portion 22 when the heating element 14 is received together with the consumable article 12 in an energy supplying cavity of an external energy supplied device, explained in further detail below. According to one embodiment of the invention, the heater 31 is a resistive element designed to be connected to a power source of the external energy supplied device. According to another embodiment, the heater 31 is formed from a heat conducting material like metal or graphene and is heated by heat transfer from a resistive element arranged in the external energy supplied device. According to a preferred embodiment of the invention, the heater 31 is a susceptor able to generate heat when it is placed in a magnetic field. The magnetic field can for example be created by the external energy supplied device, as it will be explained in further detail below. Additionally, in this case, the susceptor forming the heater 31 can also ensure heat transfer from the heat absorbing/releasing material 32 to the storage portion 22 during the vaping phase. In the example of FIG. 1, the heater 31 is formed by a plurality of rings arranged along the element axis Y and extending around this axis Y and around the receiving cavity 26.

The insulator 33 forms at least partially an outer wall of the element body 24. Thus, in the example of FIG. 1, at least a part of the heat absorbing/releasing material 32 is comprised between the heater 31 and the insulator 33. The insulator 33 can be formed from an aerogel and/or a phase change material (PCM). The insulator 33 can be wound (e.g., as a plurality of overlapping layers) and sealed as a tube or alternatively, the insulator 33 can be formed as tube. In some cases, it can be sprayed or coated on a support layer. The support layer can be wound (e.g., as a plurality of overlapping layers) and sealed as a tube or alternatively, the support layer can be formed as a tube. In some embodiments, the insulator 33 may be coated by an external layer defining an external design of the heating element 14 and/or protecting the insulator 33 from external impacts.

In the example of FIG. 1, the element body 24 is a cup comprising a bottom wall 35 delimiting transversally the receiving cavity 26. Thus, upon insertion the consumable article 12 in the receiving cavity 26, the end of the consumable article 12 opposite to its mouth end can abut against the bottom wall 35. Thus, the consumable article 12 can be accurately received inside the receiving cavity 26. However, other examples are possible, and the receiving cavity 26 could comprise a specific positioning structure, e.g. a stopper, to stop the consumable article in a defined position in the cavity.

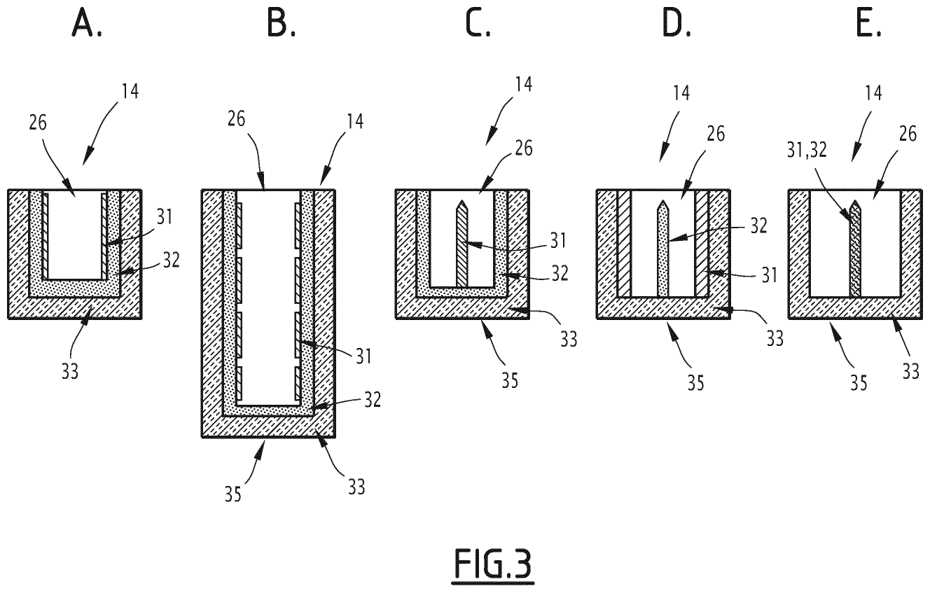

In the example of FIG. 1, the bottom wall 35 is formed by the insulator 33. However, other examples are also possible. In the example B of FIG. 3, the bottom wall 35 comprises an inner layer formed by the heat absorbing/releasing material 32 and an outer layer formed by the insulator 33.

As mentioned before, in the example of FIGS. 1 and 2, the element body 24 is adapted to receive entirely the storage portion 22 of the consumable article 12. In this case, the heating element 14 has an elongated shape. Similarly, the heating element 14 of the example B of FIG. 3 also has an elongated shape. However, according to other embodiments, the heating element 14 may have a shortened shape. In this case, the receiving cavity 26 is adapted to receive only a part of the storage portion 22 of the consumable article 12. As it is shown in FIG. 3, the heating elements 14 according to the examples A, C, D and E has a shortened shape in comparison with the example B.

Other respective arrangements and/or shapes of the heater 31, the heat absorbing/releasing material 32 and the insulator 33 inside the element body 24 are also possible.

In the example A of FIG. 3, the heater 31 is formed by a unique ring delimiting radially the receiving cavity 26.

In the example C of FIG. 3, the receiving cavity 26 is delimited by the heat absorbing/releasing material 32 and the heater 31 presents a protruding member like a blade which protrudes from the bottom wall 35 and is designed to penetrate the storage portion 22 of the consumable article 12. In this case, the bottom wall 35 has also for example two layers: one formed by the insulator 33 and the other formed by the heat absorbing/releasing material 32.

In the example D of FIG. 3, the heater 31 is formed by a unique ring delimiting radially the receiving cavity 26 and is in contact with the insulator 33. In this example, the heat absorbing/releasing material 32 is comprised in a protruding member like a blade which protrudes from the bottom wall 35 and is designed to penetrate the storage portion 22 of the consumable article 12. The protruding member can be made from a heat-conducting material like metal. In this last example, the bottom wall 35 is formed by the insulator 33. In the examples A, B and C, the insulator 33 is in direct contact with the heat absorbing/releasing material 32. In the example D, the insulator 33 is in direct contact with the heater 31 and with the storage portion 22.

In the example E, the heat absorbing/releasing material 32 and the heater 31 are integrated in a protruding member like a blade which protrudes from the bottom wall 35 and is designed to penetrate the storage portion 22 of the consumable article 12. The protruding member can be made from a heat-conducting material like metal. According to this example, the heater 31 comprises one or several susceptors which are for example mixed with the heat absorbing/releasing material 32. As in the example D, the bottom wall 35 of the example E is formed by the insulator 33. Additionally, in this example E, the insulator 33 surrounds and is in direct contact with the storage portion 22. It is thus clear that in the same example E, the insulator 33 also surrounds the elements 31 and 32 without being in direct contact with them.

Of course, any other combination of the above examples of the heating element 14 is also possible. Additionally, the heating element 14 can be provided without the bottom wall 35 and form thus a ring instead of a cup.

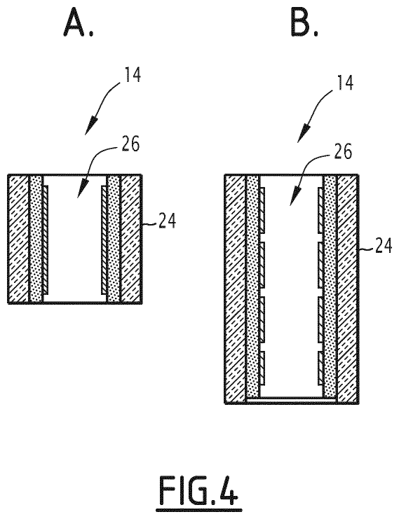

FIG. 4 shows examples A and B of such a ring those insulator, heat absorbing/releasing material and heater dispositions are similar respectively to the examples A and B of FIG. 3. In this case, the receiving cavity 26 presents a through hole. Moreover, in some embodiments, the heater 31 can comprise a plurality of susceptors mixed with or embedded within the heat absorbing/releasing material 32.

The heat absorbing/releasing material 32 is a thermal energy storage (TES) material. Depending on different examples of this material explained below, the heat absorbing/releasing material 32 can be comprised in a casing. The casing can be sealed or comprise at least one opening to compensate volume expansion of this material. In some embodiments, the casing can form a heat transfer element which facilitates heat transfer from and to the heat absorbing/releasing material 32. According to other embodiments, a heat transfer element is arranged inside the casing and forms for example a foil, grid, a mesh or particles designed to be in contact with the heater 31. The heat transfer element can be made of metal as for example aluminium, or graphene.

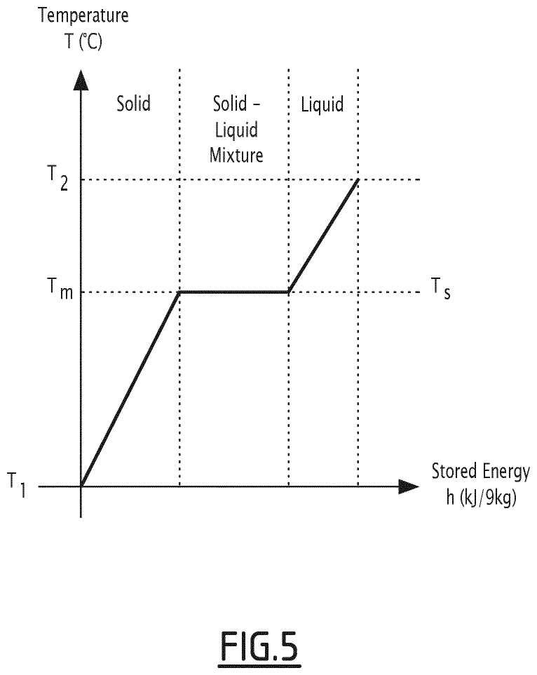

According to a preferred embodiment of the invention, the heat absorbing/releasing material 32 is a phase change material (PCM) able to absorb/release heat during its phase changing, and notably during its solid-liquid phase changing. As shown in FIG. 5, such a material is able to absorb heat while being heated from its initial temperature T₁ in solid phase until its melting temperature Tm, then isothermally until a full phase transition into the liquid phase, and then from the melting temperature Tm in liquid phase until it achieves temperature T₂. Temperature T₂ can be slightly greater or equal to the melting temperature Tm. The heat absorbed isothermally while the phase changing corresponds to latent heat. Thus, the pre-heating phase can comprise the full solid-liquid phase changing to absorb a greater amount of heat without increasing the material's temperature.

While cooling the heat absorbing/releasing material 32, it can release heat according substantially the same profile as one shown in FIG. 5. Particularly, the heat absorbing/releasing material is able to release heat while being cooled from temperature T₂ until its solidification temperature Ts, then isothermally until a full phase transition into the solid phase, and then from the solidification temperature Ts until it achieves temperature T₁. As in the previous case, the heat released isothermally while the phase changing corresponds to latent heat. This heat is particularly useful during the vaping phase to heat homogeneously the storage portion 22. Thus, the duration of the solidification phase can be adapted to an overall duration of a vaping session.

In the example of FIG. 5, the melting temperature Tm corresponds substantially to the solidification temperature Ts. However, in some embodiments, these temperatures may be different. Notably, the solidification temperature Ts can be at least slightly greater than the melting temperature Tm. This can be achieved by adding an additive into the heat absorbing/releasing material 32. This additive can interact with the phase change material in liquid phase so as to change at least some of its properties, like its concentration for example. This interaction can comprise at least one chemical reaction between the additive and the phase change material.

In a preferred embodiment of the invention, the phase change material comprises a salt or a eutectic mixture of salts, as for example salt hydrates MₓN_{y}H₂O. The phase transition temperature (as for example the melting temperature) of such a material is comprised between 150° C. and 450° C., advantageously between 200° C. and 400° C. This temperature range is suitable for evaporating the vaporizable material without burning it. Additionally, when an additive is used to change the solidification temperature Ts, this additive can change the salt's concentration or its nature or its proportion in the mixture.

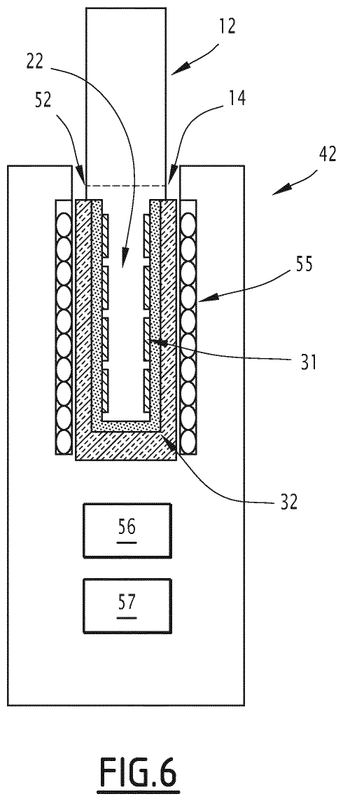

An example of an external energy supplied device 42 is shown in FIG. 6. The external energy supplied device 42 of this example is particularly adapted to operate with a heating element 14 having an elongated shape.

In the example of FIG. 6, the external energy supplied device 42, called here-below device 42, is a portable device, for example similar to an aerosol generating device, such as an HNB device. Particularly, the device 42 comprises a housing 51 defining an energy supplying cavity 52 configured to receive the heating element 14 together with the consumable article 12 and notably the storage portion 22 of the consumable article 12 when the heating element 14 is in the engaged position. In some embodiments, the cavity 52 can be further adapted to receive only a consumable article without the heating element 14. In both cases, the device 42 can operate with the consumable article 12 as a known HNB device, i.e., a device that generates aerosol when the consumable article 12 is received in the energy supplying cavity 52 with or without the heating element 14.

The housing 51 comprises various internal components of the device 42 ensuring its various functionalities. For example, the housing 51 comprises a heat generator 55 to generate heat on the heater 31, a controller 56 to control the operation of the heat generator 55 and a battery 57 to power the heat generator 55 and the controller 56.

The battery 57 is for example a known battery designed to be charged using the power supply furnished by an external source and to provide a direct current of a predetermined voltage. The battery 57 can be associated to a battery charger which is able to connect it to the external source and comprises for this purpose a power connector (like for example a mini-USB or USB-C connector) or wireless charging connector. The battery charger is also able to control the power delivered from the external source to the battery 57 according for example to a predetermined charging profile. Such a charging profile can for example define a charging voltage of the battery depending on its level of charge. In some alternative embodiments, instead of the battery 57, the housing 51 can comprise only a power connector connecting, for example by wire, the device 42 to an external power source. In this case, the device 42 is able to operate only when it is connected to this external power source.

The controller 56 is configured to control the operation of the heat generator 55 by controlling its powering by the battery 57 or in the alternative embodiment, by the external power source. For this purpose, the controller 56 is for example able to apply a predetermined heating profile to control the operation of the heat generator 55. In some embodiments, the heating profile may be chosen depending on the nature of the consumable article 12. For example, when the consumable article 12 is used with the heating element 14 to generate aerosol out of the device 42 (i.e., out-of-device mode), a specific heating profile ensuring only a pre-heating phase of this article 12, can be used. This heating profile can comprise powering the heat generator 55 only during a predetermined time interval to ensure the pre-heating phase of the consumable article 12. More generally, the heating profile can comprise powering the heat generator 55 until a predetermined triggering event occurs. This event comprises for example the expiry of a predetermined time delay as explained above or achieving a predetermined temperature or pressure in the neighbourhood of the consumable article 12 or consumption of a predetermined amount of energy by the heat generator 55. This temperature or pressure can be determined by sensors arranged in this neighbourhood, in particular, in the heating cavity or adjacent to it or on the heating element. In both cases, the heating profile may comprise powering the heat generator 55 during the pre-heating phase of the consumable article 12 according to a maximal power capacity of the heat generator 55. When the consumable articles 12 is used with or without the heating element 14 to generate aerosol while being received in the energy supplying cavity 52 of the device 42 (in-device mode), the heating profile can also ensure a vaping phase, i.e. heating the article while it is being used by the user.

Depending on different embodiments of the heater 31 of the heating element 14, the heat generator 55 can comprise a pair of power contacts designed to power the heater 31, a resistive element designed to transfer heat to the heater 31 and/or a magnetic element designed to generate a magnetic field around the heater 31. In the preferred embodiment of the invention where the heater 31 comprises a susceptor, the heat generator 55 comprises a magnetic element like a magnetic coil. In the example of FIG. 6, the heat generator 55 is formed by a magnetic coil extending along the whole length of the energy supplying cavity 52. Thus, in this example, the heat generator 55 is adapted to generate a magnetic field according to the whole length of the heater 31 which heats simultaneously the storage portion 22 and the heat absorbing/releasing material 32.

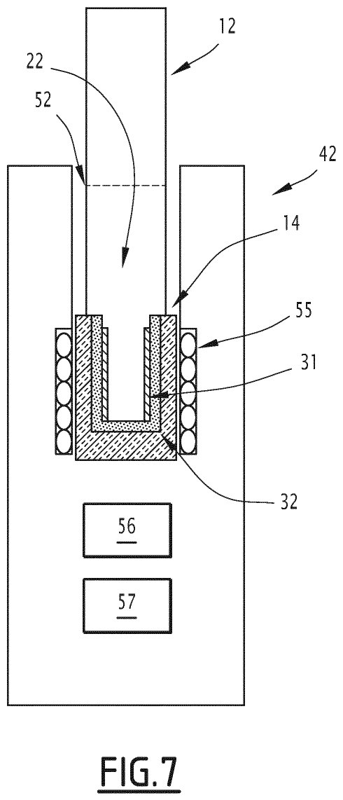

FIG. 7 shows another example of an external energy supplied device 42. The external energy supplied device 42 of this example is particularly adapted to operate with a heating element 14 having a shortened shape.

The main difference of this example from the example of FIG. 6 consists in a way of arrangement of the heat generator 55. Particularly, in this case, the heat generator 55, such as a magnetic coil, is arranged to face only the heating element 14. Thus, in this example, the heat generator 55 extends only according to a part of the energy supplying cavity 52. The length of this part is for example substantially equal to the length of the heating element 14.

In the example of FIG. 7, the device 42 further comprises a secondary heater 65 arranged to heat the part of the storage portion 22 of the consumable article 12, which extends from receiving cavity 26 of the heating element 14. In other words, the secondary heater 65 is arranged to heat the part of the storage portion 22 which is not heated by the heater 31 of the heating element 14. The secondary heater 65 comprises for example a resistive element, such as a thin film, forming at least partially an internal wall of the energy supplying cavity 52. For example, the secondary heater 65 can be arranged to face or be in contact with the part of the storage portion 22 which is not heated by the heater 31 of the heating element 14. Thus, in this example, the heat generator 55 and the secondary heater 65 extend successively along the energy supplying cavity 52. Additionally, according to this example, the controller 56 is adapted to further control the operation of the secondary heater 65. This heater 65 can be controlled according to the same heating profile as the heat generator 55 or according to a special heating profile chosen based for example on the nature of the vaporizable material. Additionally, the heating profile for the secondary heater 65 may be chosen to ensure a better heat distribution inside the storage portion 22 as well as an optimal temperature of the vaporizable material which avoids for example aerosol generation during the pre-heating phase and optimize aerosol generation during the vaping phase. For example, the secondary heater 65 may be controlled to pre-heat the vaporizable material to a temperature slightly below its vaporisation temperature.

A method for producing aerosol using a consumable kit 10 will now be explained. It is considered initially that the kit 10 is extracted from the device 42 and the consumable article 12 is disengaged from the heating element 14. When the kit 10 is intended to be used, the user engages the consumable article 12 with the heating element 14 and inserts both elements in the device 42. Then, the user activates the operation of the device 42. Alternatively, the operation of the device 42 is activated automatically upon insertion of the kit 10.

Then, a pre-heating phase is carried out. During this pre-heating phase, the controller 56 powers the heat generator 55 and eventually the secondary heater 65 according to the corresponding heating profile(s). The heat generator 55 causes heating generating by the heater 31 of the heating element 14. The heat generated by the heater 31 is transferred to the heat absorbing/releasing material. In case of a phase change material, the heat is transferred until a full phase transition into the liquid phase. The end of the pre-heating phase corresponds to a triggering event and is indicated for example by the controller 56 using an appropriate visual and/or sound indicator. The pre-heating phase can last for example at least 10 seconds, advantageously at least 15 seconds. For example, the pre-heating phase lasts from about 60 to 600 seconds.

During the pre-heating phase, the heat generator 55 and/or the secondary heater 65 may also be configured to heat the vaporizable material in the storage portion 22 to increase its temperature to a point vapor is generated as soon as it is disengaged from the device 42. As a result, the heat absorbing/releasing material is used to maintain the aerosol material in the vaporization temperature range to sustain the vaporization over the full vaping session.

The secondary heater 65 may be controlled specifically to heat the vaporizable material in the pre-heating phase. As mentioned above, the configuration and control of the secondary heater 65 may be different from those of the heat generator 55.

The user then removes the consumable article 12 with the heating element 14 from the device 42. The consumable article 12 with the heating element 14 are now ready to be used in the vaping phase independently of the device 42. In other words, the consumable article 12 with the heating element 14 can be used as a conventional cigarette. During the vaping phase, the heat stored by the heat absorbing/releasing material 32 is released into the storage portion 22. This heats the vaporizable material which generates aerosol. The vaping phase lasts as long as the heat released is sufficient to heat the vaporizable material. For example, in case of a phase change material, the vaping phase can last until its complete solidification.

In the example described above, the consumable kit 10 is used to allow vaping in a mode where it is disengaged from the device 42, i.e., in the out-of-device mode. However, as mentioned above, the device 42, in particular heat generator 55 and/or the secondary heater 65 may be configured for heating the vaporizable material to allow vaping of the consumable article 12 while the article remains engaged in the device 42 with or without the heating element 14. This configuration may correspond to a vaping mode corresponding to an engagement of the article in the device (i.e. in-device mode). This mode may be specifically programmed when the consumable article 12 is engaged in the device 42 (with or without the heating element 14) and the mode is selectively activated by a command as a response to an order by the user or automatically. The command may be a switch configured for interchanging the vaping modes between the out-of-device vaping mode and the in-device vaping mode. The activation from one mode to another may be triggered by automatic recognition system whether the consumable article 12 is inserted with or without the heating element 14.

Such system may be any suitable recognition system known in the art such as optical (e.g. barcode), magnetic, electrical, mechanical and so on. The selected mode activation may be triggered by a button activated by the user on the device 42 or by a remote connectivity command e.g. via an App of a mobile phone. In some cases, the out-of-device mode can be activated automatically when the consumable article 12 is inserted into the device 42 with the heating element 14 and the in-device mode can be activated automatically when the consumable article 12 is inserted into the device 42 without the heating element 14. In the first case, the user can have for example a possibility to switch to the in-device mode even if the consumable article 12 is inserted into the device 42 with the heating element 14.

In some embodiments, the in-device and the out-of-device vaping modes can be used in a same vaping session. For example, in this case, the user can start the vaping session using the out-of-device mode. When, while the consumable kit 10 is being used out of the device 42, the aerosol generating capacity is exhausted, the user can insert the consumable kit 10 in the device 42 and continue the vaping session using the in-device mode. Then, when the heating element 14 is heated enough, the user can extract the consumable kit 10 and continue the vaping session using the out-of-device mode.

In some embodiments, the energy suppled device 42 can further be configured to carry out a recharging phase when it is used in the out-of-device mode. Particularly, according to these embodiments, the energy suppled device 42 and notably the controller 56 are configured to carry out a recharging phase once a vaping phase is finished and the heating element 14 is needed to be recharged in order to continue the vaping session. According to some examples, the recharging phase can be carried out by the controller 56 similarly to the pre-heating phase. The end of the recharging phase case also correspond to a triggering event as explained above. According to some other examples, the recharging phase can be carried out by the controller 56 using specific heating profiles which ensure the heat absorbing/releasing material heating from a temperature which is higher than the ambient temperature. These heating profiles may thus be different from the heating profiles used during the pre-heating phase. Similarly to the pre-heating phase, the end of the recharging phase can be indicated for example by the controller 56 using an appropriate visual and/or sound indicator. In some cases, the duration of the recharging phases can be adjusted by using a temperature sensor arranged in contact or in the neighborhood of the heating element 14.

Additionally, the energy supplied device 42 may define a shape making it possible easy extraction and/or insertion of the consumable kit 10 from/in the energy supplying cavity 52. For example, the energy supplied device 42 can form a flat shape. In this case, the energy supplying cavity 52 can have a semi-cylindrical shape and be formed on an external surface of the device 42. The energy supplied device 42 can thus imitate a classical ashtray habitual for the smokers of conventional cigarettes.

The duration of each of the vaping phase and recharging phase can be adapted to habits of conventional cigarette smokers. For the example, the duration of the vaping phase can correspond to several continuous puffs, for example 2 or 3 puffs, exerted by the user. According to another example, the duration of the vaping phase can correspond to a single puff. The duration of the recharging phase can correspond to a duration generally used by a smoker to remove ash from a conventional cigarette and notably, to a duration used by some smokers to keep a conventional cigarette in contact with an ashtray. Such a duration can be comprised between 1 s and 60 s, advantageously between 2 s and 30 s, and preferably between 3 s and 20 s. In some cases, this duration can be adapted by the user or be learnt by the controller 56 of the device 42 based on user inhabits, using for example machine learning techniques. In some cases, the user can chose a vaping profile among a plurality of vaping profiles, including for example quick vaping profile, relaxing vaping profile, etc. Each of this vaping profiles defines the duration of the heating and recharging phases. In some case, this duration is not constant and can vary based on the moment of the vaping session.

In order to adapt the durations of the pre-heating and/or recharging phases as explained above, the controller 56 can adapt the corresponding heating profiles. For example, if the duration of a recharging phase is needed to be prolonged, the controller 56 can change the corresponding heating profile to increase power supplying. Thus, the corresponding triggering event (as for example achieving of a predetermined temperature) may occur at the end of the desired duration of the recharging phase.

### Second Embodiment of the Invention

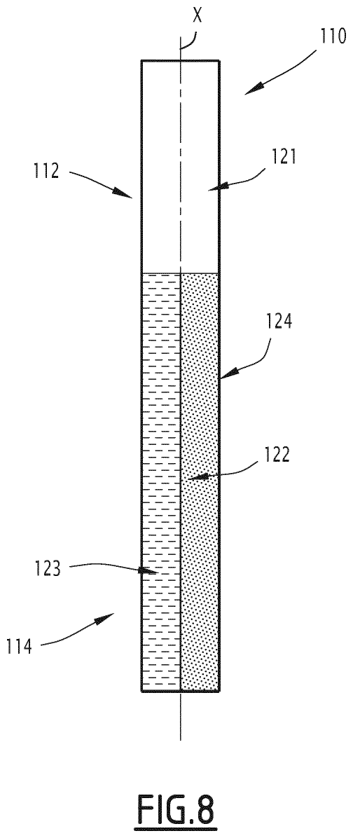

A consumable kit 110 according to the second embodiment of the invention is shown in FIG. 8. According to this Figure, the consumable kit 110 comprises a consumable article 112 and a heating element 114 which is integrated into the consumable article 112 according to the second embodiment of the invention. Particularly, according to this embodiment, the heating element 114 forms a heating portion 123 of the consumable article 112 which will be explained in further detail below.

The consumable article 112 extends according to an article axis X and has a generally cylindrical shape. This cylindrical shape can form a circle in each its cross-section. Advantageously, as in the previous embodiment, the consumable article 112 has a shape and/or dimensions which are substantially equal to those of a conventional cigarette. However, in some alternate embodiments, the consumable article 112 may have other handy shapes than a conventional cigarette, such as parallelepipedal type, pebble type shape, etc. The consumable article 112 may also be of larger size (e.g. in longitudinal or circumferential direction) than a conventional cigarette without it being detrimental to the way it is handled and consumed by the user.

The consumable article 112 comprises a filter/cooler portion 121, a storage portion 122 containing a vaporisable material and the heating portion 123 mentioned above. These portions can be assembled together by a common wrapper 124 comprising paper, aluminium foil or combinations thereof. In the example of FIG. 8, the filter/cooler portion 121 extends according to the article axis X and is adjacent to both storage and heating portions 122, 123. In this case, each of the storage and heating portions 122, 123 extends according to the article axis X at different sides of a central plane passing through the centre of the article 112 according to the article axis X. In other words, in this case, each of the storage and heating portions 122, 123 forms in their cross-section a semicircle. According to another example (not shown), the heating portion 123 extends around the storage portion 122. Thus, in each cross-section, the heating portion 123 can form an annular portion around a concentric circle of the storage portion 122. According to still another example, the storage portion 122 is arranged around the heating portion 123. In the example of FIG. 8, the heating portion 123 extends according to the whole axial length of the storage portion 122. According to still another embodiment (not shown), the portions 121, 122, and 123 extend successively according to the article axis X, the storage portion 122 being arranged between the filter/cooler portion 121 and the heating portion 123. Of course, other portion arrangements inside the consumable article 112 are still possible. In an embodiment, two or more heating portions may be present and distant one another in the consumable. For example, the heating portions may be longitudinally and/or circumferentially distant.

The filter/cooler portion 121 is similar to the filter/cooler portion 21 explained in relation with the previous embodiment.

The heating portion 123 is designed to absorb heat when the kit 110 is received in an energy supplying cavity of an external energy supplied device (i.e. pre-heating phase of operation) and to release heat to heat the storage portion 122 when it is out of the cavity (vaping phase of operation). For this purpose, the heating portion 123 comprises a heat absorbing/releasing material which is a thermal energy storage (TES) material, as explained in detail in relation with the previous embodiment. Depending on different examples of this material explained below, the heat absorbing/releasing material can be comprised in a casing. The casing can be sealed or comprise at least one opening to compensate volume expansion of this material. In some embodiments, the casing can form a heat transfer element which facilitates heat transfer from the cavity to the heat absorbing/releasing material. According to other embodiments, a heat transfer element is arranged inside the casing and forms for example a foil, grid, a mesh or particles designed to be in contact with at least one wall of the cavity. The heat transfer element can be made of metal, as for example aluminium.

In the example of FIG. 8, the consumable article 112 can also comprise an insulator (not-shown) movable between a rest position and an insulating position. In the insulating position, it is designed to cover the heating portion 123 and in the rest position, it is designed to uncover the heating portion 123. For example, in the rest position, the insulator can cover the filter/cooler portion 121 and/or the storage portion 122. The insulator can comprise an insulation sleeve or ring slidable along the article axis X between the rest position and the insulating position. According to another example, the insulator can have a half-cylindrical shape and can be mounted rotary in respect with the article axis X between the rest position and the insulating position.

The insulator can be formed from an aerogel and/or a phase change material (PCM). In some cases, it can be sprayed or coated on a support layer.

In the example where the storage portion 122 is arranged around the heating portion 123 and at least a part of an external heater penetrates inside the heating portion 123, the insulator can form a fixed external layer, comprising for example an aerogel and/or a phase change material (PCM). In this case, the support layer can be formed by the common wrapper 124.

As mentioned above, for carry out the pre-heating phase, the consumable kit 110 is designed to be received in an energy supplying cavity of an external energy supplied device.

Such cavity and such device are for example similar to those illustrated in FIG. 6 and explained in reference to this FIG. 6. In this case, the heat generator 55 can comprise a resistive heater which can be arranged in the energy supplying cavity to be in contact with the heating portion 123. For example, this resistive heater can extend only on one side of the cavity to be in contact with the heating portion 123. According to another embodiment, the resistive heater extends on both sides of the cavity to be further in contact with the storage portion 122. In some embodiments, the heat generator 55 can comprise a heating blade configured to penetrate the heating portion 123.

The method for producing aerosol using a consumable kit 110 according to the second embodiment is similar to the method explained in relation with the first embodiment. Contrary, to this last, the consumable kit 110 according to the second embodiment is provided already assembled. Thus, there is no need to engage the heating element 114 with the consumable article 112. Accordingly, the consumable kit 110 can be directly inserted into the energy supplying cavity to carry out the pre-heating phase and then, be extracted from the cavity to carry out the vaping phase according to the out-of-device mode or be kept in the cavity to carry out the vaping phase according to the in-device mode. In the out-of-device mode, a recharging phase as explained above can also be carried out.

### Third Embodiment of the Invention

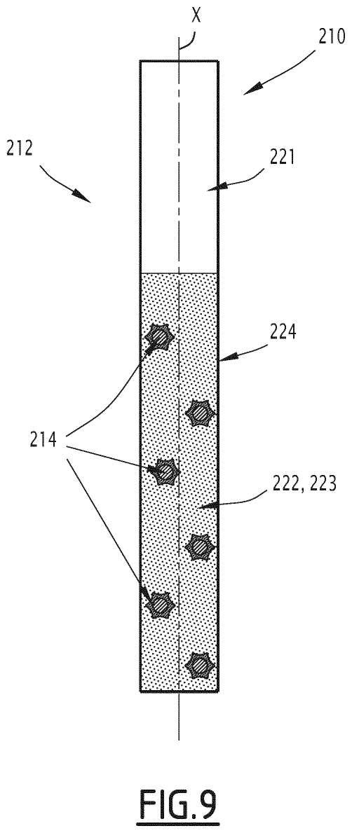

A consumable kit 210 according to the third embodiment of the invention is shown in FIG. 9. According to this Figure, the consumable kit 210 comprises a consumable article 212 and a plurality of heating elements 214 which form a heating portion 223 of the consumable article 212.

Particularly, as show in FIG. 9, the consumable article 212 comprises a filter/cooler portion 221, a storage portion 222 and the heating portion 223 mentioned above. These portions can be assembled together by a common wrapper 224. In the example of FIG. 9, the heating portion 223 is integrated in the storage portion 222. This means that the content of the heating portion 223 is not placed side-by side with the storage portion as in the previous embodiment but is mixed with or embedded within the content of the storage portion 222 so that the heat is distributed from more than one direction to the vaporizable material as it will be explained below. According to other examples (not-shown), the storage and heating portions 222, 223 can be arranged in any other suitable manner.

According to some examples of the third embodiment, the consumable article 212 can further comprise an insulator arranged around the storage portion 222. This insulator can be fixed and can for example be formed by at least a part of the common wrapper 224. Like in the previous case, the insulator can be formed from an aerogel and/or a phase change material (PCM). It can for example be sprayed or coated on a support layer formed by common wrapper 224.

The filter/cooler portion 221 is similar to the filter/cooler portions 21, 121 explained above. As in the previous case, the storage portion 222 contains a vaporizable material.

According to the third embodiment, each heating element 214 comprises or forms a susceptor able to generate heat when it is placed within a magnetic field. The heating elements 214 are mixed within the storage portion 222.

Each heating element 214 further comprises a heat absorbing/releasing material able to absorb heat generated by the susceptors during a pre-heating phase (i.e. when the storage portion 222 is received in an energy supplying cavity and to release this heat to heat the vaporizable material during a vaping phase (i.e. when the consumable kit 210 is removed from the cavity). The heat absorbing/releasing material can be similar to one explained in relation with the previous embodiments. Particularly, as in the previous cases, the heat absorbing/releasing material can comprise a phase change material (PCM) and in some cases, an additive, as explained above.

In the example of FIG. 9, the susceptors are formed for example by balls, discs or rings mixed with the vaporizable material. Additionally, the susceptors are coated by a coating layer formed from the heat absorbing/releasing material. A retaining structure can further be provided around the susceptors to retain the coating layer close to the corresponding susceptors while the heat absorbing/releasing material changes its phase.

As mentioned above, for carry out the pre-heating phase, the consumable kit 210 is designed to be received in an energy supplying cavity of an external energy supplied device. Such cavity and such device are for example similar to those illustrated in FIG. 6 and explained in reference to this FIG. 6. In this case, the heat generator 55 can comprise a magnetic coil arranged around the energy supplying cavity 52.

The method for producing aerosol using a consumable kit 210 according to the second embodiment is similar to the method explained in relation with the previous embodiments. Similarly to the second embodiment, the consumable kit 210 according to the third embodiment is provided already assembled. Thus, there is no need to engage the heating element(s) 214 with the consumable article 212. Accordingly, the consumable kit 210 can be directly inserted into the energy supplying cavity to carry out the pre-heating phase and then, be extracted from the cavity to carry out the vaping phase according to the out-of-device mode or be kept in the cavity to carry out the vaping phase according to the in-device mode. In the out-of-device mode, a recharging phase as explained above can also be carried out. Particularly, during the pre-heating phase, the storage portion 22 is received within the energy supplying cavity and the susceptors comprised in the heating elements 214 generate heat which is absorbed by the heat absorbing/releasing material. The pre-heating phase can be carried out until the heat absorbing/releasing material changes its phase for the liquid phase. During the vaping phase in the out-of-device mode, the consumable kit 210 is removed from the device. The vaporizable material is heated by heat released from the heat absorbing/releasing material until its complete solidification.

1. A heating element for a consumable article, the consumable article comprising a storage portion storing a vaporizable material, the heating element comprising an element body configured to be engaged in an engaged position at least partially around the storage portion of the consumable article and be disengaged with the consumable article;
the element body further configured to be removably received at least partially in an energy supplying cavity of an external energy supplied device;
the element body comprising a heat absorbing/releasing material configured to:
absorb heat during a pre-heating phase carried out when the element body is engaged with the consumable article and received in the engaged position with the consumable article in the energy supplying cavity of the external energy supplied device; and
while the element body is in the engaged position with the consumable article, release the absorbed heat to the storage portion to the vaporizable material during a vaping phase carried out upon a triggering event;
the element body further comprising a heater comprising at least one susceptor configured to generate heat upon inductive interaction with the external energy supplied device.

2. The heating element according to claim 1, wherein said heat absorbing/releasing material is a phase change material (“PCM”) configured to absorb/release heat during its phase changing.

3. The heating element according to claim 1, wherein the heater is configured to:
during the pre-heating phase, generate heat and transfer the heat to the heat absorbing/releasing material; and/or
during the vaping phase, transfer heat from the heat absorbing/releasing material to the vaporizable material.

4. The heating element according to claim 1, wherein the heater is configured to be arranged at least partially around the storage portion of the consumable article and/or penetrate the storage portion of the consumable article, when the element body is in the engaged position with the consumable article.

5. The heating element according to claim 1, wherein the heater is configured to be interposed between the storage portion of the consumable article and the heat absorbing/releasing material, when the element body is in the engaged position with the consumable article.

6. The heating element according to claim 1, wherein the heater comprises a plurality of susceptors mixed with or embedded within the heat absorbing/releasing material.

7. The heating element according to claim 1, wherein the element body further comprises a protruding member configured to penetrate the storage portion of the consumable article, when the element body is in the engaged position with the consumable article;
wherein the protruding member comprises a heater and/or at least a part of said heat absorbing/releasing material.

8. The heating element according to claim 1, claims, wherein the element body further comprises an insulator arranged at least partially around the heat absorbing/releasing material and/or configured to be arranged at least partially around the storage portion.

9. The heating element according to claim 1, wherein the element body forms a ring or a cup able to be engaged with the consumable article by sliding along an article axis (X).

10. The heating element according to claim 1, further comprising anchoring means configured to fix the element body on the consumable article, when the element body is engaged with the consumable article.

11. The heating element according to claim 1, wherein the triggering event comprises achieving a predetermined temperature of the vaporizable material in the storage portion, expiring a predetermined time delay, achieving a predetermined pressure in a neighbourhood of the consumable article or consuming a predetermined amount of energy from a power source.

12. A consumable kit comprising:
a consumable article comprising a storage portion storing a vaporizable material; and
a heating element comprising a heat absorbing/releasing material configured to:
absorb heat during a pre-heating phase carried out when the consumable kit is received in an energy supplying cavity of an external energy supplied device; and
release the absorbed heat to the storage portion to the vaporizable material during a vaping phase carried out upon a triggering event.

13. A vaping set, comprising:
an external energy supplied device comprising an energy supplying cavity; and
a consumable kit according to claim 12.

14. A method for producing an aerosol from a consumable kit according to claim 12, the method comprising the following steps:
upon engagement of the consumable kit with an external energy supplied device, carrying out a pre-heating phase by heating the heating element of the consumable kit; and
upon a triggering event, carrying out a vaping phase by heating the vaporizable material by the heating element.

15. The method for producing an aerosol according to claim 14, further comprising the following step:
upon engagement of the consumable kit with the external energy supplied device after the vaping phase, carrying out a recharging phase to re-heat the heating element.

16. The heating element according to claim 2, wherein said phase change material (PCM) is configured to melt during the pre-heating phase and solidify during the vaping phase.

17. The heating element according to claim 2, said phase change material (“PCM”) comprises a salt, a eutectic mixture of salts or salt hydrates.

18. The heating element according to claim 7, the heater comprising a susceptor.
